(19) United States
(12) Patent Application Publication
(10) Pub. No.: US 2014/0129257 A1
(43) Pub. Date: May 8, 2014

(54) DIAGNOSTIC SELECTION, TRIAGE, MONITORING, AND PATIENT CARE MANAGEMENT OF CRITICAL CARE PATIENTS USING COMPUTER-DRIVEN ASSESSMENT

(71) Applicant: DuPage Medical Group, Downers Grove, IL (US)

(72) Inventors: Krishna Ramachandran, Westmont, IL (US); Brian O'Leary, Downers Grove, IL (US); Richard Krouse, Downers Grove, IL (US); Michael Kasper, Elmhurst, IL (US); Mary Goldsher, Lake Oswego, OR (US)

(21) Appl. No.: 13/800,830

(22) Filed: Mar. 13, 2013

Related U.S. Application Data
(60) Provisional application No. 61/723,636, filed on Nov. 7, 2012.
(60) Provisional application No. 61/723,648, filed on Nov. 7, 2012.
(60) Provisional application No. 61/723,649, filed on Nov. 7, 2012.

(51) Int. Cl. G06F 19/00; G06Q 50/24

(52) U.S. Cl. CPC G06F 19/3431; G06Q 50/24
USPC 705/3

(57) ABSTRACT

High-risk patients may be enrolled in an intensive care program to reduce the likelihood of recurring symptoms. A method for identifying and enrolling these high-risk patients in the intensive care program may include receiving a plurality of patient health profiles corresponding to a plurality of patients from an electronic medical record database. Then, a first subset of patients of the plurality of patients may be identified to be at high risk of suffering an episode. Then, a patient from the first subset of patients may be enrolled in an intensive care program designed to reduce the rate of episodes for the patient. The intensive care program may involve coordinated treatments from a continuum of healthcare professions. The healthcare professionals may use data within the electronic medical record to improve treatment of the high-risk patient.

### CROSS-REFERENCE TO RELATED APPLICATIONS

This applications claims benefit of priority to U.S. Provisional Patent Application No. 61/723,636 to Ramachandran et al., filed Nov. 7, 2012, and entitled “Diagnostic Selection, Triage, Monitoring, and Patient Care Management of Critical Care Patients Using Computer-Driven Assessment;” to U.S. Provisional Patent Application No. 61/723,648 to Ramachandran et al., filed Nov. 7, 2012, and entitled “Diagnostic Selection, Triage, Monitoring, and Patient Care Management of Critical Care Patients Using Computer-Driven Assessment;” and to U.S. Provisional Patent Application No. 61/723,649 to Ramachandran et al., filed Nov. 7, 2012, and entitled “Diagnostic Selection, Triage, Monitoring, and Patient Care Management of Critical Care Patients Using Computer-Driven Assessment;” each of which is hereby incorporated by reference in their entirety.

### FIELD OF THE DISCLOSURE

The instant disclosure relates to computer databases. More specifically, this disclosure relates to the use of computer databases to assist in healthcare treatment.

### BACKGROUND

Patient healthcare is an increasingly important part of society. Research is providing many new treatment options and cures for extending the length of life and quality of life of patients. However, administering healthcare plans with such large number of treatment options can be a daunting challenge. For example, deciding when a healthcare plan will cover a particular treatment may be more difficult when there are many available treatments, each with different success rates or costs depending on other circumstances that may or may not be known.

Within the population there is an unequal consumption of healthcare services. Some members of the population require more treatments than others. Even among those members of the population that require more treatments, there exist certain members that are at high risk of needing additional treatments. For example, as many as 10-15% of sick patients, those patients receiving treatment, are members of a high-risk group. These high-risk patients are likely to require long-term treatments and combinations of treatments to maintain their quality of life.

Insurance providers that pay for the healthcare treatments of these high-risk patients often pay fixed dollar amounts for delivery of the healthcare treatments. Thus, when a high-risk patient has a recurring problem, the hospital or clinic treating that patient is incentivized to provide proper treatment and reduce recurring visits. When the hospital or clinic is able to provide effective treatment for the high-risk patient, the hospital or clinic receives increased profit by having provided fewer treatments in exchange for the same payment from the insurance provider. However, one impediment to providing successful treatment to these high-risk patients is an inability to identify the high-risk patients from within the general population of sick patients. If these high-risk patients are not identified, then they experience recurring symptoms and never receive the long-term care needed to manage symptoms.

The problem of identifying these high-risk patients is exacerbated by the large number of sick patients being treated at hospitals and clinics. Doctors, nurses, and other healthcare professionals treat such a large number of patients that they are unable to provide customized treatment plans for the high-risk patients. Without a customized plan, the high-risk patients are likely to continue to visit the hospital or clinic with the same chronic symptoms.

Prior solutions to identifying the high-risk patients are based on a chronic care management model. For example, one solution is to remove high-risk patients from their normal environment and keep them in a 24/7 care facility. Inside of the facility, the high-risk patient can be monitored to ensure that illnesses do not recur. Thus, the number of hospital and clinic visits by that high-risk patient is reduced. However, this can be even more costly than treating the patient for recurring visits, because 24/7 care is required. Further, many patients do not wish to leave their homes. Another solution is to have nurses in the hospital or clinic devoted to assessing patients and determining which patients are high-risk patients. However, with this solution the assessment nurse only has access to the patient and any records available at the hospital or clinic. That is, the nurse does not have access to healthcare records at other facilities the patient may have visited. Without those records, the nurse cannot make an accurate assessment and some high-risk patients may still go unidentified.

### SUMMARY

High-risk patients may be identified quickly with the assistance of computer-driven monitoring. After high-risk patients are identified, those high-risk patients may be placed in a healthcare program designed to reduce recurrence of symptoms. The high-risk patient's care may be managed through a computer system that is part of the same system or a different system than the computer-driven monitoring. The managed treatment for the high-risk patients may be administered in a single facility, in which the entire team of healthcare professionals have access to the computer-driven monitoring system to ensure the healthcare treatment plan is coordinated among different healthcare professionals.

For example, a single facility may house doctors, nurses (RNs), administrators, social workers, and support staff. Each of these healthcare professionals has access to the patient's records in the computer-driven monitoring and management systems. Thus, each of the healthcare professionals has knowledge of and records from treatments provided by other healthcare professionals. By providing this access, referrals between healthcare professionals may be more useful to the patient. For example, when a doctor refers a patient to a social worker for assistance changing their behavior to reduce the likelihood of a recurrence of a symptom after treatment for that symptom, the doctor can follow up to examine the treatments prescribed by the social worker. Further, should the patient have a recurrence of the symptom, the doctor can inspect the records from the social worker to determine if additional or different behavioral counseling would be useful.

According to one embodiment, a method includes receiving a plurality of patient health profiles corresponding to a plurality of patients. The method also includes identifying a first subset of patients of the plurality of patients at high risk of suffering an episode. The method further includes enrolling a patient from the first subset of patients in an intensive care program designed to reduce the rate of episodes for the patient.

According to another embodiment, a computer program product includes a non-transitory computer readable medium having code to receive a plurality of patient health profiles corresponding to a plurality of patients. The medium also includes code to identify a first subset of patients of the plurality of patients at high risk of suffering an episode. The medium further includes code to enroll a patient from the first subset of patients in an intensive care program designed to reduce the rate of episodes for the patient.

According to yet another embodiment, an apparatus includes a memory and a processor coupled to the memory. The processor is configured to receive a plurality of patient health profiles corresponding to a plurality of patients. The processor is also configured to identify a first subset of patients of the plurality of patients at high risk of suffering an episode. The processor is further configured to enroll a patient from the first subset of patients in an intensive care program designed to reduce the rate of episodes for the patient.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating an exemplary method for providing care for high-risk patients according to one embodiment of the disclosure.

FIG. 2 is a flow chart illustrating an exemplary method for identifying and enrolling high-risk patients according to one embodiment of the disclosure.

FIG. 3 is a flow chart illustrating an exemplary method for identifying and enrolling high-risk patients according to another embodiment of the disclosure.

FIG. 4A is a block diagram illustrating a system for identifying, enrolling, and administering an intensive care program for high-risk patients according to one embodiment of the disclosure.

FIG. 4B is a screen shot illustrating a patient screen with notes according to one embodiment of the disclosure.

FIG. 4C is a screen shot illustrating a form for entering patient data according to one embodiment of the disclosure.

FIG. 4D is a screen shot illustrating a listing of custom reports according to one embodiment of the disclosure.

FIG. 4E is a screen shot illustrating a patient schedule according to one embodiment of the disclosure.

FIG. 4F is a screen shot illustrating a listing of confirmed patient appointments according to one embodiment of the disclosure.

FIG. 4G is a screen shot illustrating a display of patient data according to one embodiment of the disclosure.

FIG. 4H is a screen shot illustrating assignment of a home-monitoring device to a patient according to one embodiment of the disclosure.

FIG. 4I is a screen shot illustrating a listing of results from home-monitoring devices according to one embodiment of the disclosure.

FIG. 5 is a block diagram illustrating a system for managing and analyzing healthcare data according to one embodiment of the disclosure.

FIG. 6 is a block diagram illustrating a computer network according to one embodiment of the disclosure.

FIG. 7 is a block diagram illustrating a computer system according to one embodiment of the disclosure.

FIG. 8 is a flow chart illustrating an exemplary method of enrolling a diabetes patient in an intensive care program according to one embodiment of the disclosure.

FIG. 9 is a flow chart illustrating an exemplary method for evaluating a diabetes patient in an intensive care program according to one embodiment of the disclosure.

FIG. 10 is a flow chart illustrating an exemplary method for daily care of a diabetes patient in an intensive care program according to one embodiment of the disclosure.

FIG. 11 is a flow chart illustrating an exemplary method for handling urgent issues of a diabetes patient in an intensive care program according to one embodiment of the disclosure.

FIG. 12 is a flow chart illustrating an exemplary method for following up with a diabetes patient in an intensive care program according to one embodiment of the disclosure.

### DETAILED DESCRIPTION

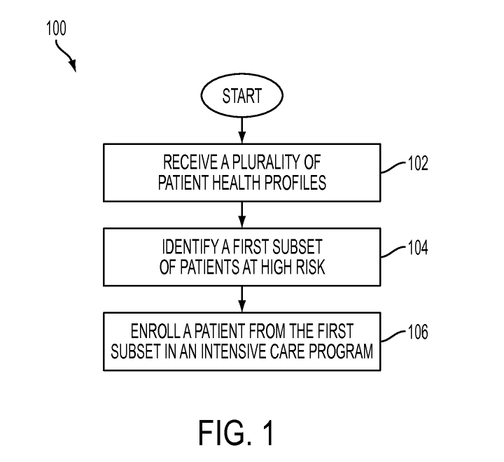

FIG. 1 is a block diagram illustrating a method of identifying and enrolling high-risk patients in an intensive care program according to one embodiment of the disclosure. A method 100 begins at block 102 with receiving a plurality of patient health profiles. The patient health profiles may be received from, for example, an electronic medical record database. The electronic medical record database may be created and managed by an institution, such as a medical group that operates hospitals and clinics. The electronic medical record database may also be a database of patient information maintained by a third-party solely for the purposes of identifying high-risk patients.

At block 104, a first subset of patients are identified from the plurality of patient health profiles received at block 102. The first subset of patients may be identified by analyzing records within the patient health profiles. For example, a telephone survey may be presented to individuals and results of the telephone survey stored in the patient health profiles. Additionally, scores may be computed based on algorithms using data from the patient health profiles as an input. Scores from the algorithms may be stored in the patient health profiles. Any patient with a score above a threshold may be identified as a patient at high risk at block 104. The patients identified at block 104 may be at high risk of suffering an episode.

At block 106, the patients identified as members of the first subset may be enrolled in an intensive care program. The intensive care program may be designed to reduce the likelihood of suffering further episodes. The care program may be administered through an outpatient clinic. The intensive care program may provide the patient with long-term care designed to provide a continuum of services directed towards reducing the number of episodes experienced by a patient. After enrollment, healthcare professionals delivering treatment to the high-risk patient may continue to use the patient's health profile stored in the electronic medical record database to monitor the patient's progress and convey information to other healthcare professionals.

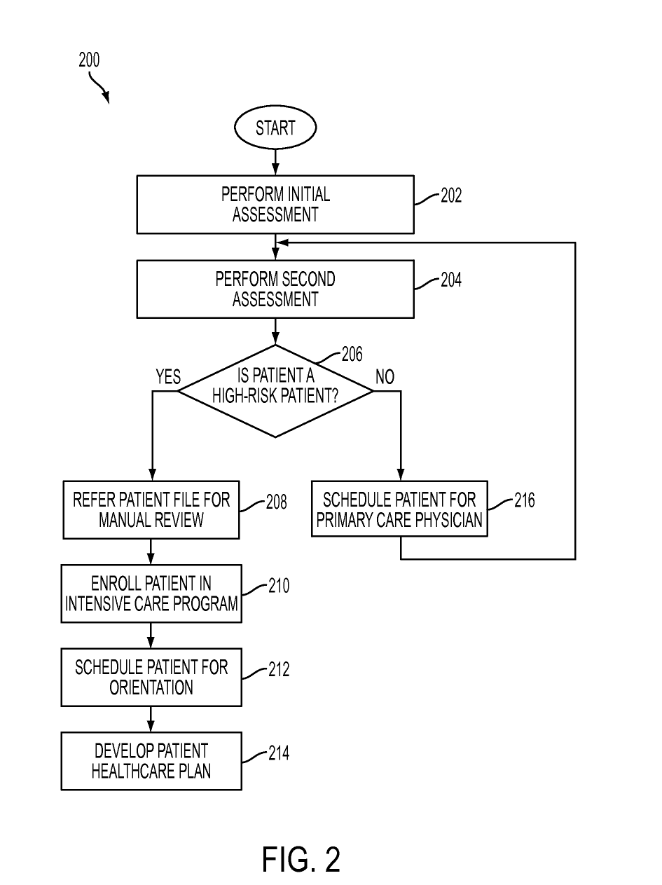

In one embodiment, the determination of whether a patient is a high-risk patient may be performed through two assessments. FIG. 2 is a flow chart illustrating an exemplary method for identifying and enrolling high-risk patients according to one embodiment of the disclosure. A method 200 begins at block 202 with performing an initial assessment. The initial assessment may be a questionnaire completed by the patient at the patient's convenience. For example, the initial assessment may be a telephone interview conducted by an automated calling system or a survey completed through a web page on a computer or mobile device.

At block 204, a second assessment may be performed on the patient after the initial assessment is complete. According to one embodiment, the second assessment may only be performed when an initial assessment results in a determination that a particular patient may be a high-risk patient. For example, the results of the initial assessment at block 202 may be stored in a patient's electronic medical record (EMR). A scan of a database of electronic medical records may flag a subset of the records for further assessment, when the score from the initial assessment is above a threshold, to determine whether the patient is a high-risk patient. Each patient flagged during the scan of initial assessment results in the electronic medical record may be further analyzed at block 204.

The second assessment at block 204 may be a clinical assessment performed automatically based, in part, on data in the patient's electronic medical record. For example, an algorithm may read the electronic medical records, including active and past prescriptions, active and past symptoms, lab results, past medical history, and/or recent doctor and specialists visits, and calculate a score for the patient. According to different embodiments, the algorithm executed at block 204 may be one or more of a Charlson score, a Humana Severity Risk score, and a Johns Hopkins PraPlus score. The score generated at block 204 may be, for example, a severity score predicting medical costs for the patient over the next 12 months using the previous 12 months of claims data from the patient's medical record.

To facilitate assessment of the patient's electronic medical record at block 204, entries in the electronic medical record may be translated into corresponding ICD-9 CM diagnosis codes, each with distinct weights to score the patient appropriately based on burden of illness. An example table of such conversion is provided below in Table 1. Additionally, the assessment at block 204 may accept as input the score generated at block 202 during the initial assessment or data collected during the initial assessment at block 202.

TABLE 1
Table of sample translations from electronic
medical record entries to ICD-9 CM codes.

| | ICD-9 |
|---|---|
| Entry | CM code |
| 2 ER or hospital admits for unstable angina or chest pain | 411.1 or |
| w/in last 12 months | 786.5 |
| 1 ER or hospital admit for weakness w/in last 12 months | 780.79 |
| 1 ER or hospital admit for dizziness w/in last 12 months | 780.4 |
| 1 ER or hospital admit for near syncope w/in last 12 months | 780.2 |
| 1 ER or hospital admit for dehydration w/in last 12 months | 276.51 |
| 1 ER or hospital admit for anxiety w/in last 12 months | 300 |
| 1 ER or hospital admit for chest pain w/in last 12 months | 786.5 |
| 1 ER or hospital admit for headache w/in last 12 months | 784 |
| 1 ER or hospital admit for chronic pain w/in last 12 months | 338.29 |
| 1 ER or hospital admit for pain w/in last 12 months | 780.96 |
| Dx = MS + 1 hospital or ER visit or 2 PCP visits w/in | 340 |
| last 3 months | |
| Dx = Alzheimers + 1 ER or hospital admit w/in last | 331 |
| 12 months | |
| Renal failure unspecified + (GFR < 60) | 586 |
| Malnutrition (calorie) BMI < 18.5 | 263.9 |
| Skin melanoma, site unspecified | 172.9 |

The score generated at block 204 may determine whether a patient is a high-risk patient at block 206. A threshold may be set to determine if the patient will be in the top 10-15% of costs. The threshold may be selected to identify patients with multiple chronic conditions that have not responded to traditional care and may also possess mental health, chemical dependency, and/or social service needs. If the patient is not a high-risk patient at block 206, then the patient may be scheduled for a visit with a primary care physician at block 216. The primary care physician may diagnose and treat the patient or refer the patient for additional assessment at block 208. After the patient is treated, the patient may occasionally or periodically be reevaluated to determine if the patient is a high-risk patient.

If the patient is determined to be a high-risk patient at block 206, the patient's record may be referred for manual review at block 208. During manual review a doctor or other healthcare professional may confirm the high-risk status of the patient. The manual review of block 208 may occur by generating a list of high-risk patients and transmitting the list through electronic mail to a healthcare professional. Alternatively, the healthcare professional may be directed to a website for interacting with the electronic medical record for the patient, where the professional may confirm or remove the patient from a high-risk group of patients. In different embodiments, no manual review may be performed for identified high-risk patients, automatic manual review may be performed on all identified high-risk patients, and manual review may be performed only on certain identified high-risk patients. For example, manual review at block 208 may be performed only if the score generated from the second assessment at block 204 is within 10% of the threshold score for identifying the patient as a high-risk patient.

After the patient is confirmed as a high-risk patient at block 208, the patient may be enrolled in an intensive care program at block 210. The intensive care program may be administered on an outpatient basis to reduce expenses related to admitting a high-risk patient repeatedly to a hospital or emergency room. The intensive care program may include the services of interventionalists, nurse practitioners, medical assistants, health coaches, case managers, physical therapists, nutritionists, pharmacists, podiatrists, psychologists, psychology counselors, dentists, certified diabetic educators (CDEs), social workers, fitness instructors, administrators, phlebotomists, x-ray technicians, and/or receptionists. Each of these healthcare professionals may interact with the patient's electronic medical records to deliver care to the patient and refer patients to other healthcare professionals. The team of healthcare professionals, with access to electronic medical records and data entered by other healthcare professionals, may develop a long-term plan for treating the patient, monitoring the patient's progress, and adjusting the patient's plan, which ultimately reduces the cost of healthcare services provided to the patient by reducing recurring chronic symptoms. As part of the intensive care program, the patient may be scheduled for orientation at block 212, where a healthcare plan is developed for the patient at block 214.

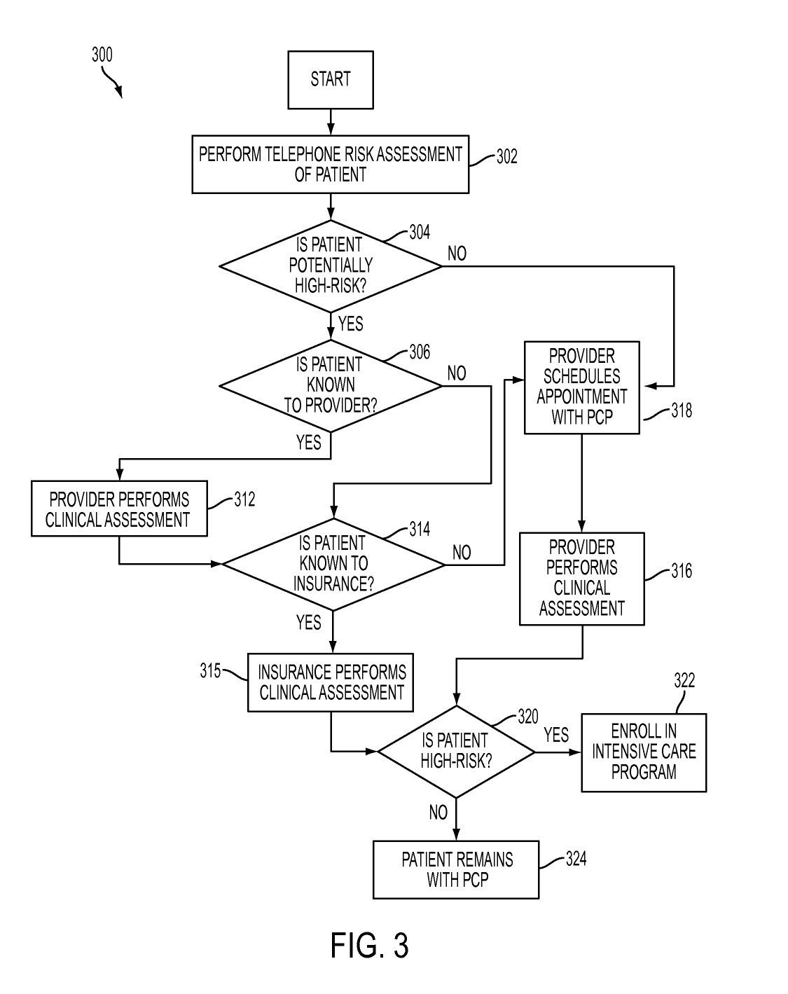

The second assessment at block 204 may be performed by one of a number of different actors. For example, a healthcare provider, such as a clinic or medical group, as well as an insurance company may both possess data regarding the patients. In one embodiment, the assessment is performed by the actor having the most information regarding the patient. FIG. 3 is a flow chart illustrating an exemplary method for identifying and enrolling high-risk patients in an intensive care program according to another embodiment of the disclosure. A method 300 begins at block 302 with an initial assessment, such as a telephone risk assessment, of a patient. If the patient is identified at block 302 as a potentially high-risk patient at block 304, the method 300 continues to block 306.

At block 306, it is determined whether the patient is known to the healthcare provider. If so, the method 300 continues to block 312 and the provider performs a clinical assessment on the potentially high-risk patient. After the provider's assessment, the method 300 continues to block 314. If the patient is unknown to the provider, method 300 continues to block 314 to determine if the patient is known to the insurance provider. If the patient is not known to the healthcare provider at block 306 it is determined at block 314 whether the patient is known to insurance.

If the patient is known to the insurance provider, the insurance provider performs a clinical and/or claims-based assessment on the potentially high-risk patient at block 315. If the patient is unknown to the insurance provider, the patient is scheduled for an appointment with their primary care physician at block 318, who performs a clinical assessment at block 316.

After performing a clinical assessment of the potentially high-risk patient at blocks 312, 315, and/or 316, it is determined at block 320 whether the patient is, in fact, a high-risk patient. If the patient is identified as a high-risk patient, then the patient may be enrolled in an intensive care program at block 322. If not, then the patient remains with their primary care physician (PCP) at block 324.

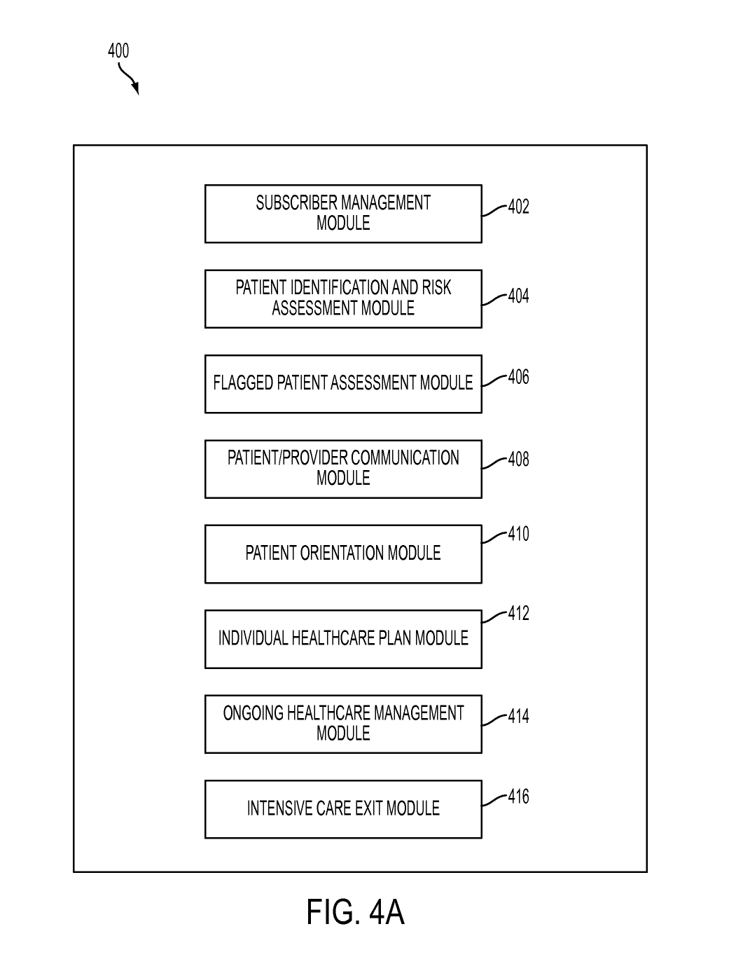

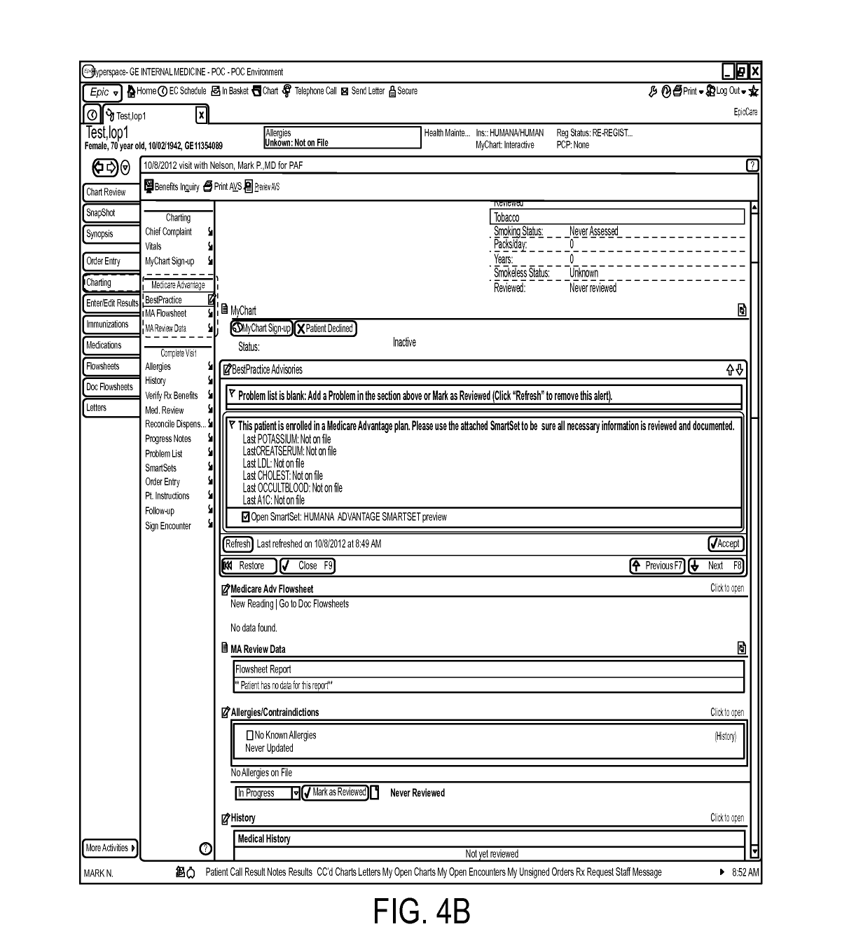

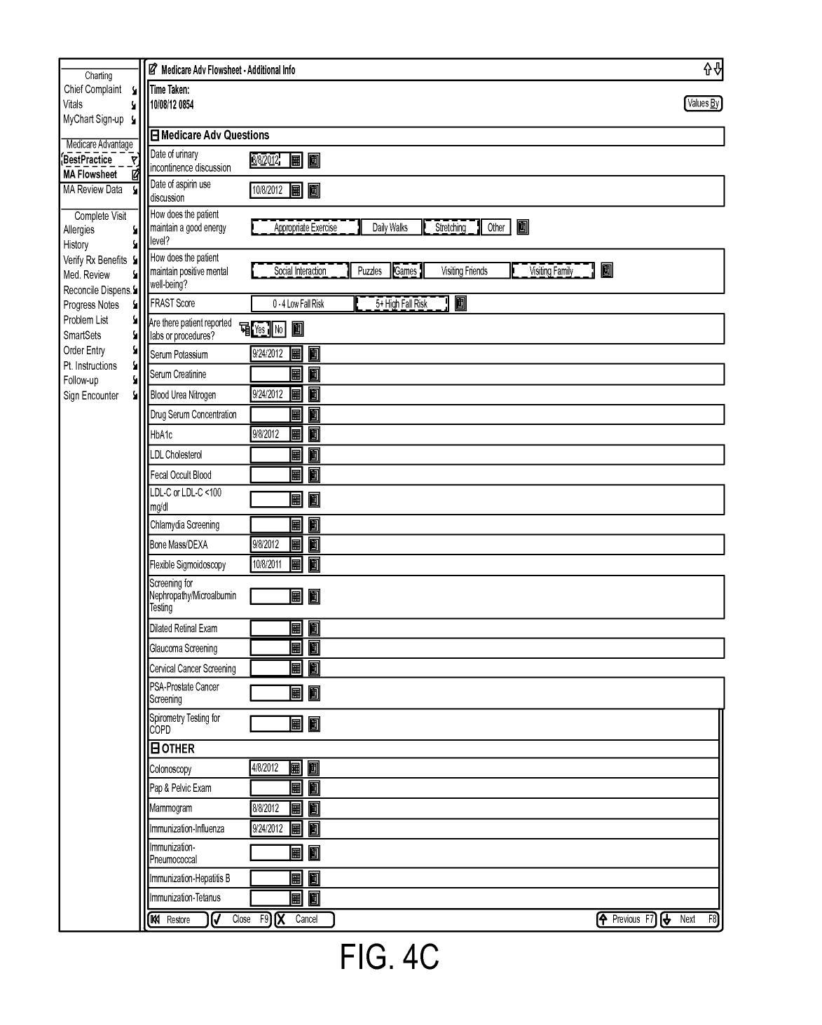

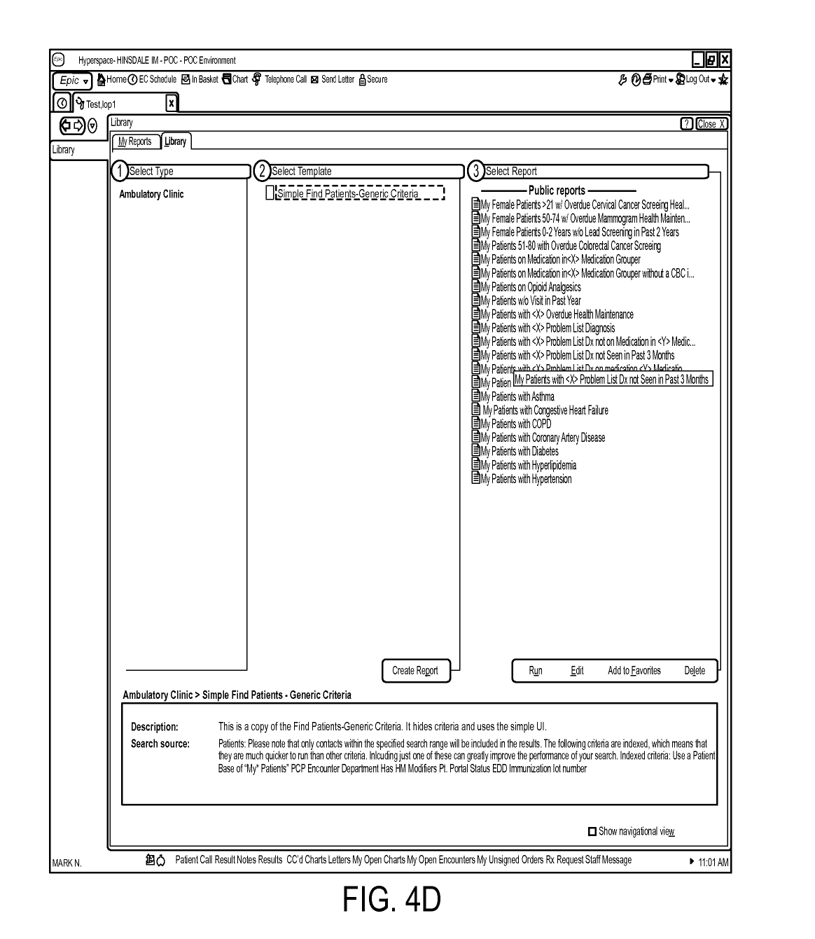

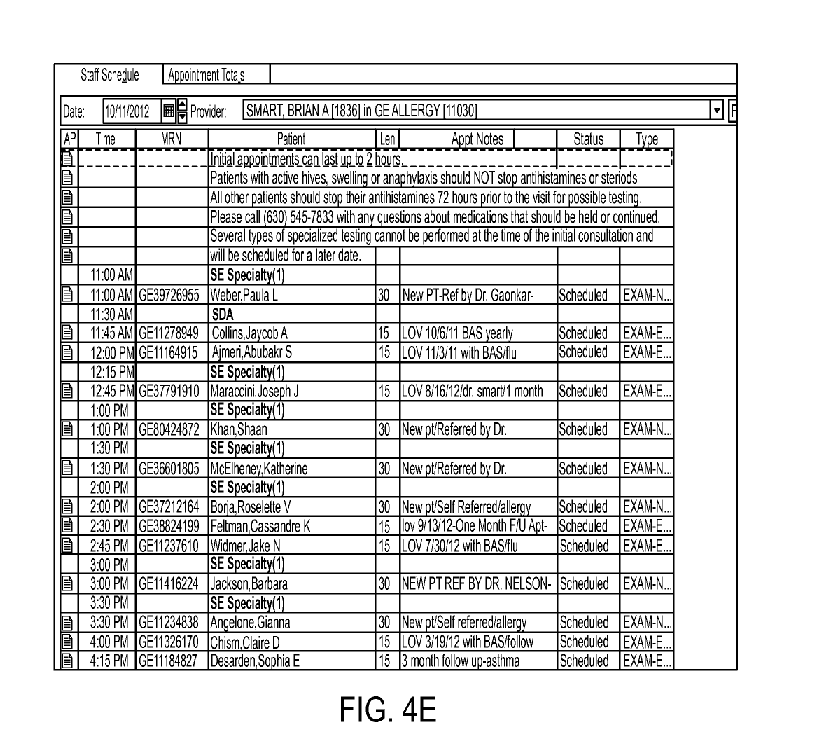

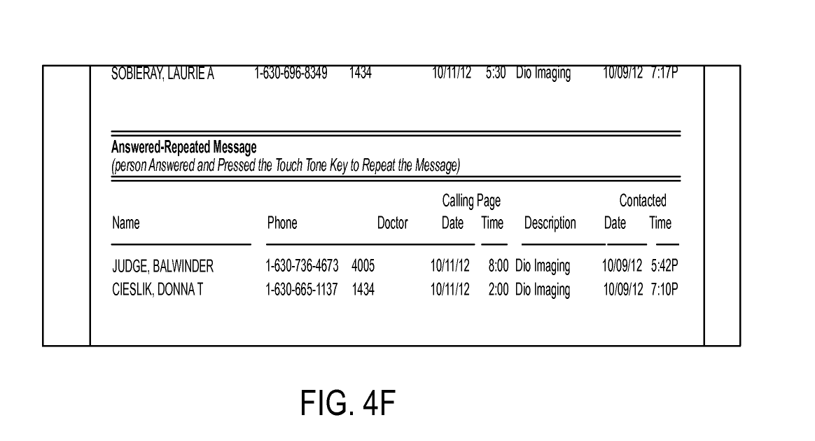

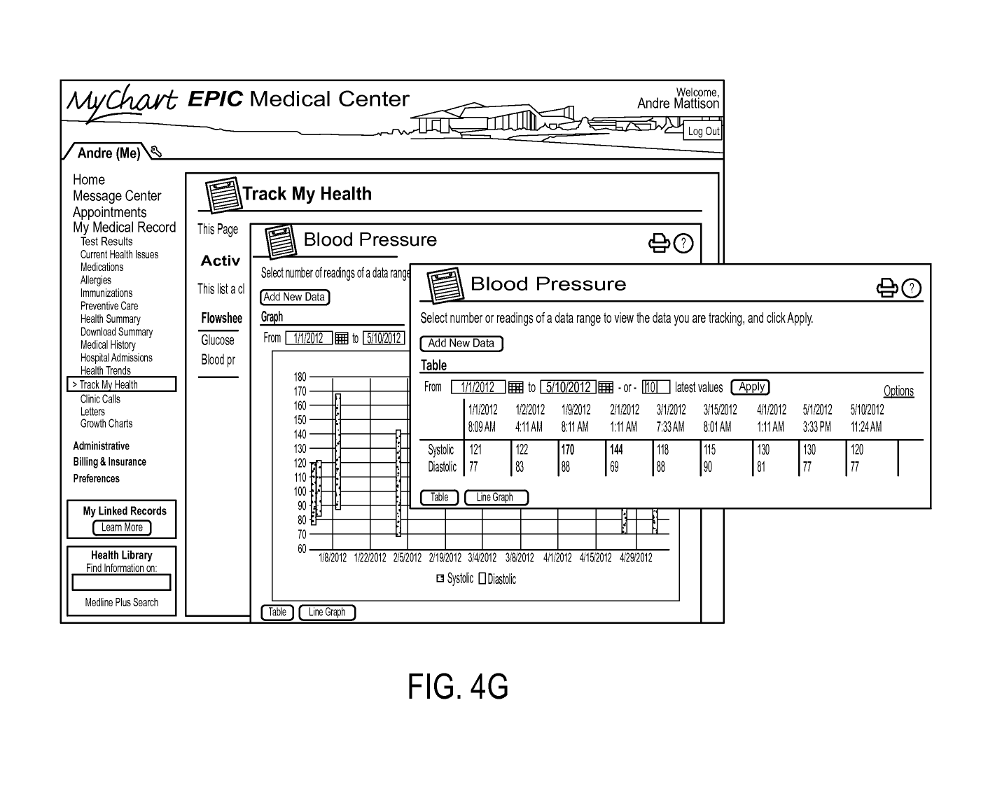

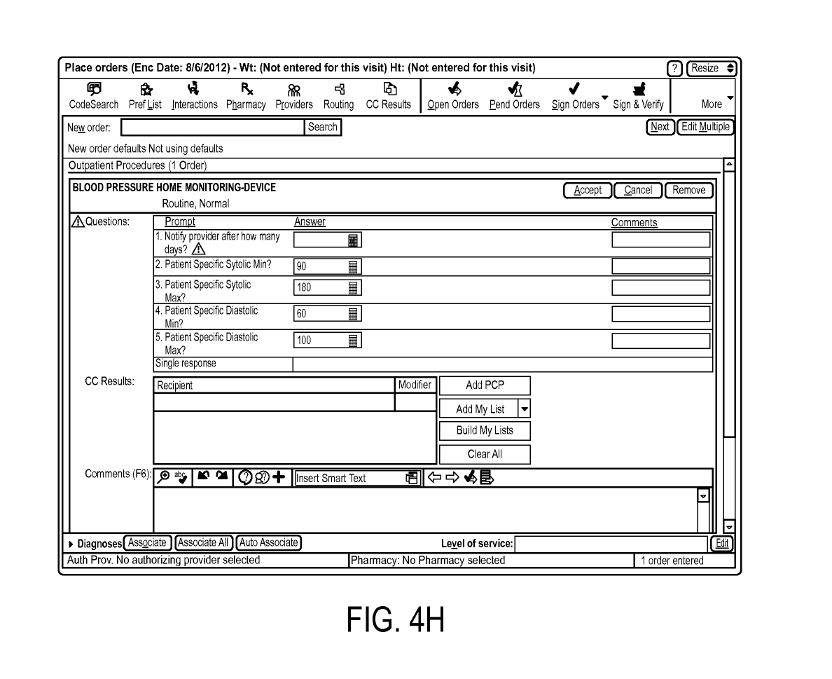

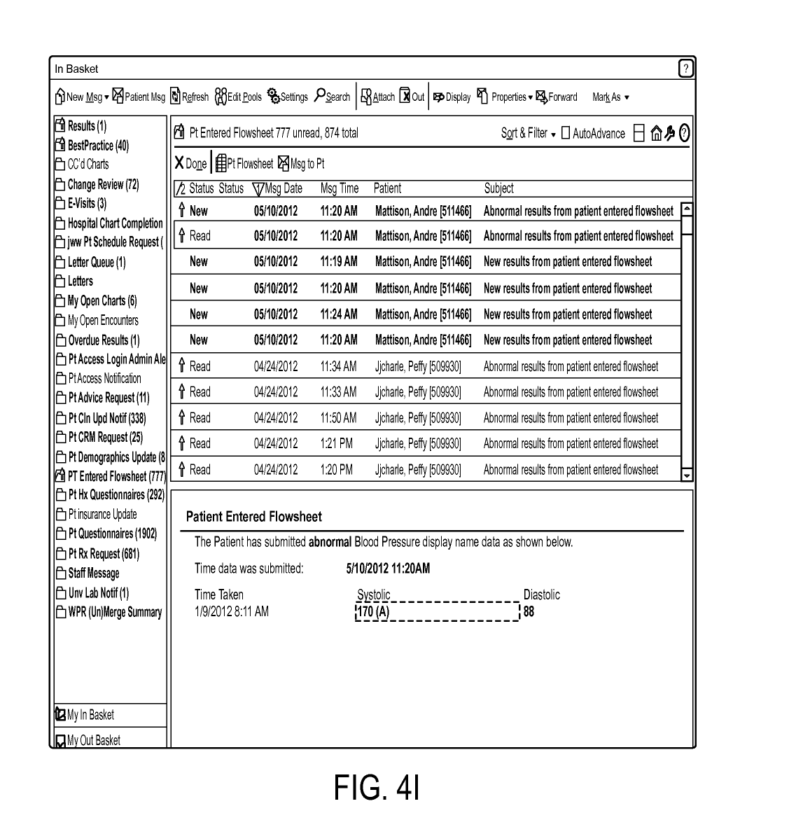

FIG. 4A is a block diagram illustrating a system for identifying, enrolling, and administering an intensive care program for high-risk patients according to one embodiment of the disclosure. A risk management tool 400 may include modules for performing different functions. For example, the risk management tool 400 may include a subscriber management module 402. The subscriber management module 402 may include code to determine who is enrolled in the intensive care program. For example, the module 402 may include code to coordinate new subscribers between a healthcare provider and an insurance company. The module 402 may also coordinate potential subscribers between the healthcare provider and insurance company to schedule initial assessments of potentially high-risk patients. When a new subscriber is added to an intensive care program, notes may be provided to the healthcare professional indicating additional information required as part of the intensive care program as illustrated in FIG. 4B. A health coach, or other healthcare professional, may enter the data in a form as illustrated in FIG. 4C. After a patient is enrolled in the intensive care program, reports may be generated to identify particular patients in the program. For example, FIG. 4D illustrates a selection of reports, such as identifying patients without a visit in the past year, patients with asthma, patients with diabetes, etc.

The risk management tool 400 may also include a patient identification and risk assessment module 404. The module 404 may include code to initiate an initial assessment, code to clinically assess patients based on electronic medical records, code to obtain risk scores from outside services, code to compute risk scores based on data in available electronic medical records, code to create flagged patient files for manual review, code to call patients without accessible data to schedule an appointment with a health coach/physician, and/or code to reassess the status of potentially high-risk patients.

The risk management tool 400 may further include a flagged patient assessment module 406. The module 406 may include code to allow team review of patient appropriateness for an intensive care program and/or code to assign a patient to a particular site in an intensive care program.

The risk management tool 400 may also include a patient/provider communication module 408. The module 408 may automatically generate notifications to enrolled patients with orientation dates and request an RSVP. The module 408 may also automatically follow-up with subscribers to confirm attendance at the orientation.

The risk management tool 400 may further include a patient orientation module 410. The module 410 may include code to create schedules for patients, code to generate welcome notifications for patients, code to assign particular healthcare providers to the healthcare plan for the patient, code to notify the patient of patient rights and responsibilities and record the patient's acknowledgement, code to provide palliative care discussion, code to assist the patient in goal setting, and/or code to enroll the patient in an online account to view a portion of their electronic medical records pertaining to the intensive care program. The module 410 may create a schedule of patients for a healthcare professional along with note regarding that patient as illustrated in FIG. 4E. After scheduling appointments for patients, the appointments may be confirmed by an automated contact system, such as through a recorded telephone voice message. A summary of confirmations may be generated as illustrated in FIG. 4F. Additional information may be provided to the patient through a web interface, where a patient may track their health information and results over time, such as illustrated in FIG. 4G.

The risk management tool 400 may also include an individual healthcare plan module 412. The module 412 may include code to create a clinical treatment plan, code to set patient goals, code to assess a patient's readiness to change, code to create a medication therapy management plan, code to create a physical therapy plan, code to create a social services plan, code to create a home assessment plan, code to create a home health monitoring plan, code to assess transportation needs, code to create a patient education plan, and/or code to create an end-of-life plan. When a home health monitoring plan includes home monitoring devices, the devices may be configured through a form as illustrated in FIG. 4H. For example, a blood pressure monitoring device may be configured to report information at certain intervals and have minimum and maximum acceptable values. When a home device reports a value outside of the acceptable values, an alert may be generated, such as the illustrated in FIG. 4I illustrating an abnormal systolic blood pressure value.

The risk management tool 400 may further include an ongoing healthcare management module 414. The module 414 may include code to schedule daily care conferences, code to create a pre-visit plan, code to manage a patient registry, code to perform health monitoring through home monitoring and/or self assessments, code to create a patient outreach plan, and/or code to create a rapid response plan.

The risk management tool 400 may also include an intensive care exit module 416. The module 416 may include code to determine whether a patient has met clinical goals and/or personal goals and/or code to discharge a patient to the care of a primary care provider.

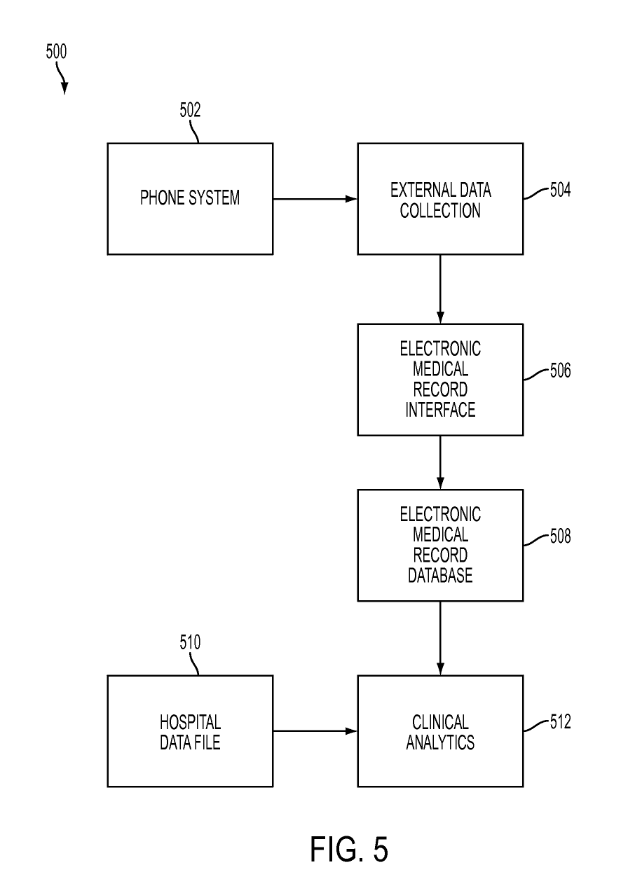

The risk management tool 400 may access data collected and stored in different database systems. FIG. 5 is a block diagram illustrating a system for managing and analyzing healthcare data according to one embodiment of the disclosure. A system 500 may include an electronic medical record database 508, which stores a plurality of patient profiles. The patient profiles may include symptoms, diagnoses, and treatments provided by healthcare professionals. The patient profiles may be aggregated from several disparate medical record databases. The patient profiles may also be entered through an electronic medical record interface 506 at a clinic or other healthcare facility.

According to one embodiment, the electronic medical record interface 506 may include an application programming interface (API) to allow the automated entry of data obtained from an external data collection system 504. For example, the external data collection system 504 may be a telephone survey system coupled to a phone system 502. The external data collection system 504 may collect a patient's answers to questions to determine a patient's potential of being a high-risk patient. The answers to the questions and/or a risk assessment score calculated from the answer may be entered into the electronic medical record database 508 through the electronic medical record interface 506.

A clinical analytics system 512 may receive data from the electronic medical record database 508 and other data sources, such as a hospital data file 510. For example, the clinical analytics system 512 may have access to the electronic medical record database 508 through an application programming interface (API). The hospital data file 510 may be provided to the clinical analytics system 512 through occasional updates. For example, one per week or once per month a new hospital data file 510 may be provided to the clinical analytics system 512. The hospital data file 510 may be manually made available to the clinical analytics system 512 or automatically fetched, such as from a file transfer protocol (FTP) server.

The clinical analytics system 512 may receive data and calculated risk assessment scores that assist in determining whether a patient is a high-risk patient. For example, the electronic medical record interface 506 may receive a plurality of patient profiles entered by healthcare professionals and/or obtained through external data collection 504. The electronic medical record interface 506 may store the patient profiles in the electronic medical record database 508 and provide the patient profiles to the clinical analytics system 512. The patient profiles may be provided to the clinical analytics system 512 individually or in groups. The clinical analytics system 512 may then return risk assessment scores to the electronic medical record interface 506, which may store the risk assessment scores in the database 508. The electronic medical record interface 506 may then identify high-risk patients from the plurality of patient profiles stored in the electronic medical record database by, for example, comparing the risk assessment scores to a threshold value. The electronic medical record interface 506 may then enroll the high-risk patient in an intensive care program by altering a value on the high-risk patient's electronic medical record in the electronic medical record database 508. After the high-risk patient is enrolled, the electronic medical record interface 506 may schedule an orientation for the high-risk patient and enter the orientation date and time into the electronic medical record database 508. According to one embodiment, the clinical analytics system 512 may also receive an input listing claims data from payors to improve accuracy of the determinations.

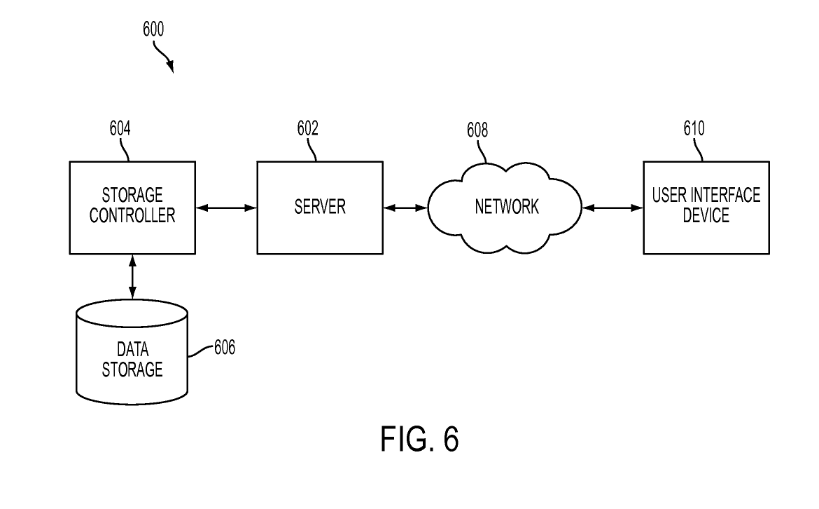

FIG. 6 illustrates one embodiment of a system 600 for an information system, including a system for storing electronic medical records. The system 600 may include a server 602, a data storage device 606, a network 608, and a user interface device 610. The server 602 may be a dedicated server or one server in a cloud computing system. In a further embodiment, the system 600 may include a storage controller 604, or storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other a mobile communication device having access to the network 608. The user interface device 610 may be, for example, an analytics system that receives electronic medical records from the data storage 606. In a further embodiment, the user interface device 610 may access the Internet or other wide area or local area network to access an application or web service hosted by the server 602 and provide a user interface for enabling a user, such as a healthcare professional, to enter or receive information.

The network 608 may facilitate communications of data, such as information in an electronic medical record, between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

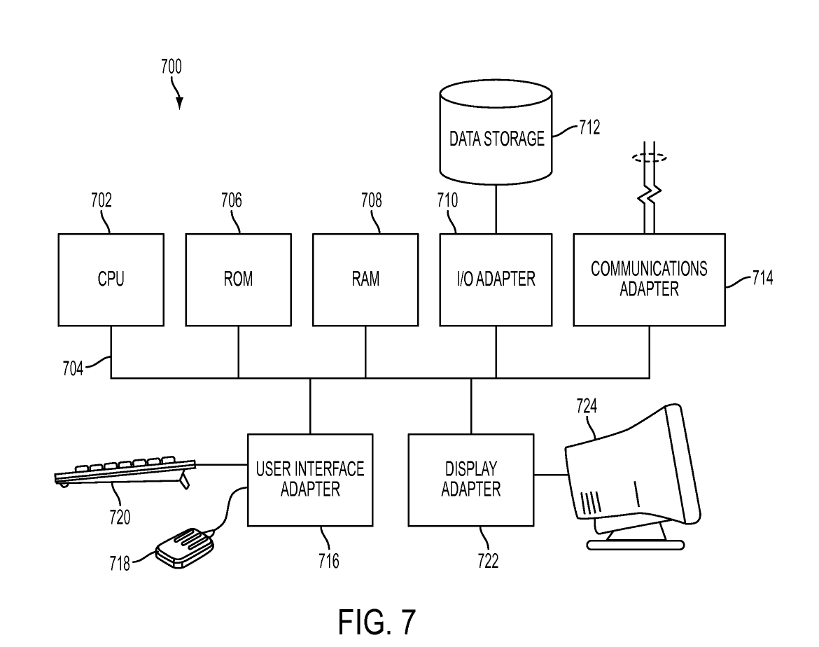

FIG. 7 illustrates a computer system 700 adapted according to certain embodiments of the server 602 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 also may include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM 706 may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 608, which may be one or more of a LAN, WAN, and/or the Internet. The communications adapter 714 may also be adapted to couple the computer system 700 to other networks such as a Bluetooth network. The user interface adapter 716 couples user input devices, such as a keyboard 720, a pointing device 718, and/or a touch screen (not shown) to the computer system 700. The keyboard 720 may be an on-screen keyboard displayed on a touch panel. The display adapter 722 may be driven by the CPU 702 to control the display on the display device 724.

The applications of the present disclosure are not limited to the architecture of computer system 700. Rather the computer system 700 is provided as an example of one type of computing device that may be adapted to perform the functions of the server 602 and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

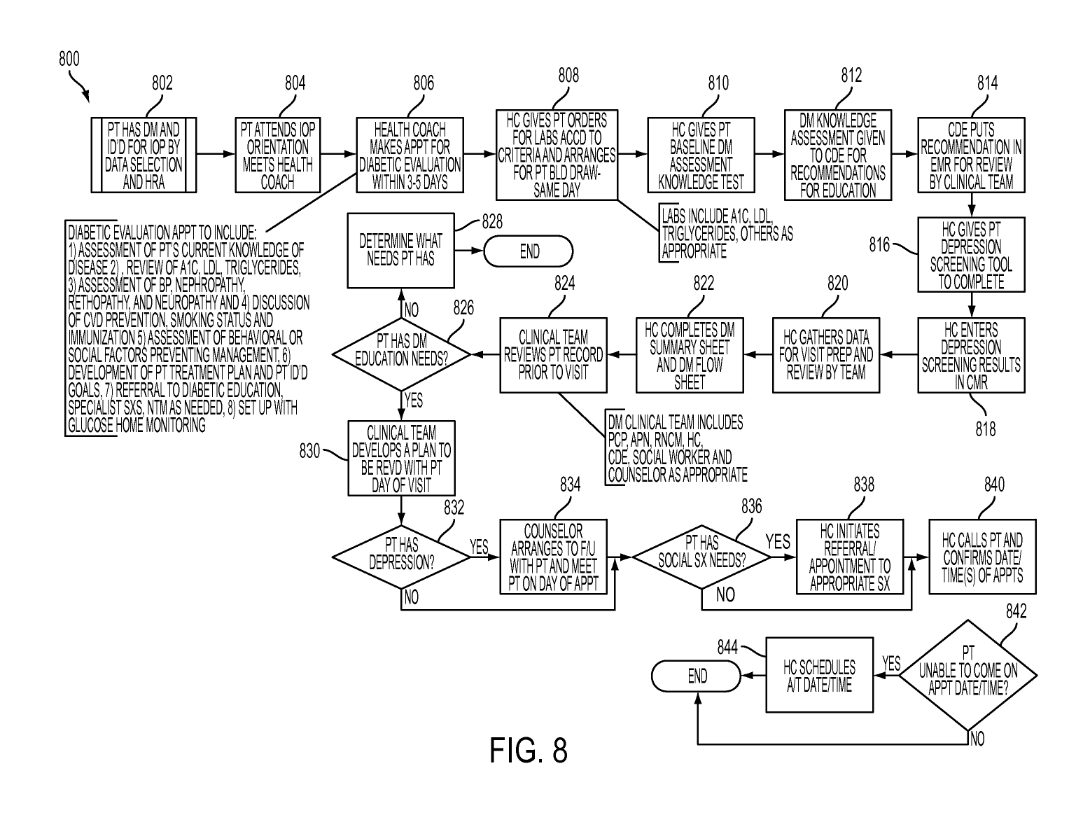

One application for the intensive care program described above may be for the treatment of high-risk patients with diabetes. FIG. 8 is a flow chart illustrating an exemplary method of enrolling a diabetes patient in an intensive care program according to one embodiment of the disclosure. A method 800 begins at block 802 with a patient being identified as a high-risk patient and enrolled in an intensive care plan. At block 804, the patient attends orientation for the intensive care plan and sets an appointment for a diabetic evaluation at block 806. At block 808, a health coach assigned at orientation at block 804 selects lab tests for the patient, which are used at block 810 to create a baseline assessment of the patient. At block 812, an education plan is created for the patient, and at block 814, the patient is reviewed by a clinical team.

At block 816, the patient may complete a depression screening test, and the results of the test may be entered into the patient's electronic medical record at block 818. At block 820, the healthcare coach gathers data from the electronic medical records for the patient and reviews the records along with other healthcare professionals. At block 822 the health coach may create a summary sheet, which is reviewed by an assigned team of healthcare professionals at block 824.

At block 826 it is determined whether the patient requires additional educational instruction. If no, then the method 800 continues to block 828 to determine if the patient has any other needs. If additional education is needed, then the method 800 proceeds to block 830, at which the clinical team develops an educational plan.

At block 832, it is determined whether the patient has depression. The determination may be performed by, for example, examining the patient's electronic medical record and, in particular, data entered into the electronic medical record at block 818. If not, then the method 800 proceeds to block 836. If yes, then an appointment with a counselor may be scheduled at block 834, and the method 800 proceeds to block 836.

At block 836, it is determined whether the patient has social needs. If not, then the method 800 proceeds to block 840. If so, then an appointment with an appropriate healthcare professional is scheduled at block 838, and the method 800 proceeds to block 840.

At block 840, the health coach informs the patient of the date and time of the one or more appointments scheduled in method 800, such as an appointment with a counselor, a doctor, or other healthcare professionals. The notification to the patient may be generated by the electronic medical record system, such as by creating an electronic mail message or making an automated telephone call with a recording of the appointment times.

At block 842, it is determined whether the patient is unable to attend any scheduled appointments. When the notification of the appointment times is automated, the patient may indicate a problem by pressing a designated set of keys on a telephone keypad during an automated call or by clicking a particular link embedded in the electronic mail message. If no conflicts arise, then the method 800 ends. If conflicts exist, then the method 800 proceeds to block 844 to schedule alternate appointment times for the patient.

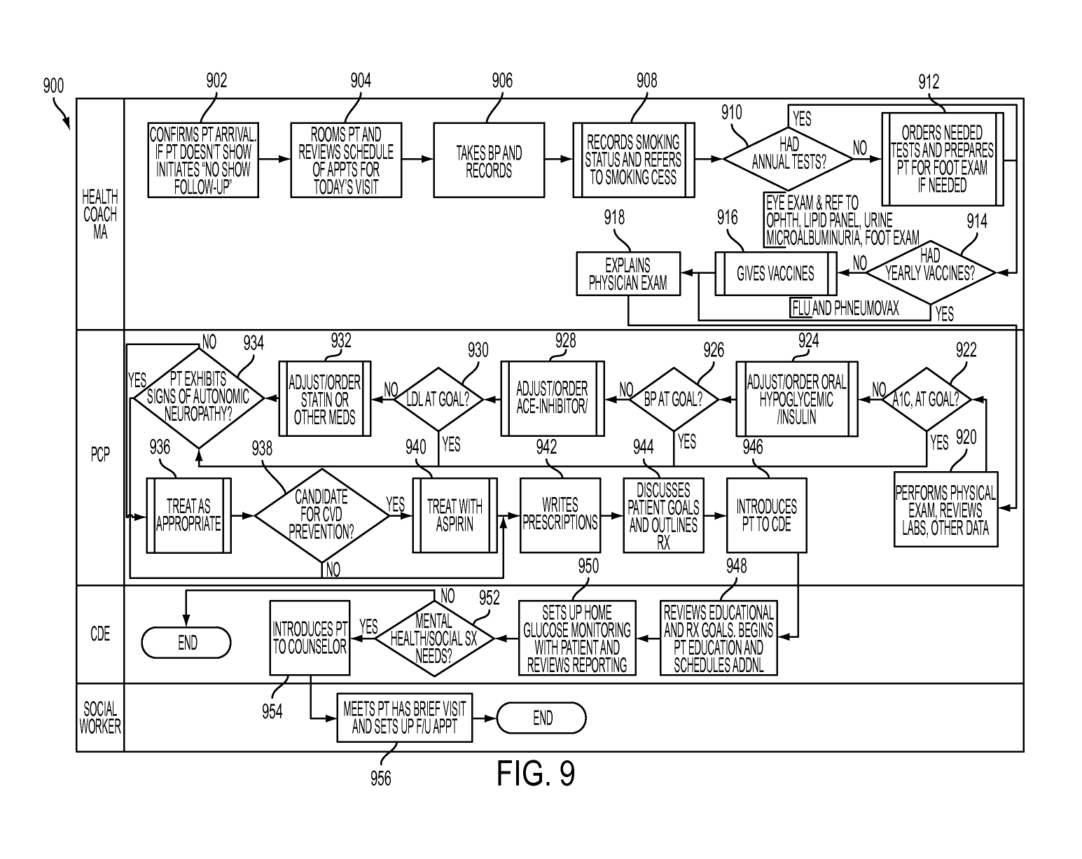

FIG. 9 is a flow chart illustrating an exemplary method for evaluating a diabetes patient in an intensive care program according to one embodiment of the disclosure. At block 902, a health coach confirms the high-risk patient has arrived and reviews the scheduled appointments with the patient at block 904. At block 906, the health coach takes blood pressure measurements and collects other data, which may be entered into the patient's electronic medical records. At block 908, the health coach records a smoking status of the patient, such as quantity of cigarettes consumed per day. At block 910, it is determined whether the patient had annual tests, such as eye exams and lipid panels. If not, the method 900 proceeds to block 912, at which tests may be scheduled for the patient. If annual tests are already completed, the method 900 continues to block 914. At block 914, it is determined whether the patient has received yearly vaccines. The patient may be questioned and answers input into the patient's electronic medical record if the record does not already have vaccine status for the patient. If the patient has already received yearly vaccines, the method proceeds to block 918. If vaccines are necessary, the vaccines may be given to the patient at block 916, and then the method 900 proceeds to block 918.

At block 918 the health coach explains to the patient the physician examination, and the patient is handed off to a primary care physician (PCP) who performs a physical exam at block 920. At block 922, it is determined whether an glycated hemoglobin (AlC) value for the patient has reached a goal value. If so, the method 900 continues to block 926. If not, oral hypoglycemic and/or insulin may be prescribed for the patient or previous prescriptions may be adjusted at block 924. At block 926, it is determined whether the patient's blood pressure has reached a goal value. If so, the method 900 proceeds to block 930. If not, angiotensin-converting-enzyme (ACE)-inhibitors and/or angiotensin receptor blockers (ARB) may be prescribed for the patient or previous prescriptions may be adjusted at block 928. At block 930, it is determined whether the patient's low-density lipoprotein (LDL) value has reached a goal value. If so, the method 900 proceeds to block 932. If not, statin or other medications may be prescribed for the patient, or previous prescriptions may be adjusted, at block 930. At block 934, it is determined whether the patient exhibits signs of autonomic neuropathy. If not, then the method 900 proceeds to block 938. If yes, then the patient is treated at block 936. At block 938 it is determined whether the patient is a candidate for cardiovascular disease (CVD) prevention. If not, then the method 900 proceeds to block 942. If so, then the patient is treated with aspirin at block 940. At block 942, the patient is provided prescriptions by the primary care physician. Data regarding the prescriptions and notes from the primary care physician, may be entered in the patient's electronic medical record.

At block 944, the primary care physician discusses goals with the patient and introduces the patient to a certified diabetic educator at block 946. At block 948, the certified diabetic educator reviews educational and medical goals. At block 950, home glucose monitoring may be setup for the patient. At block 952, it is determined whether the patient requires the attention of a social worker. If not, the method 900 ends. If yes, then the certified diabetic educator introduces the patient to a social worker at block 954.

At block 956, the social worker meets the patient and sets up appointments. The appointments may be notated in the patient's electronic medical record, such that other healthcare professionals are aware that the patient is undergoing social therapy.

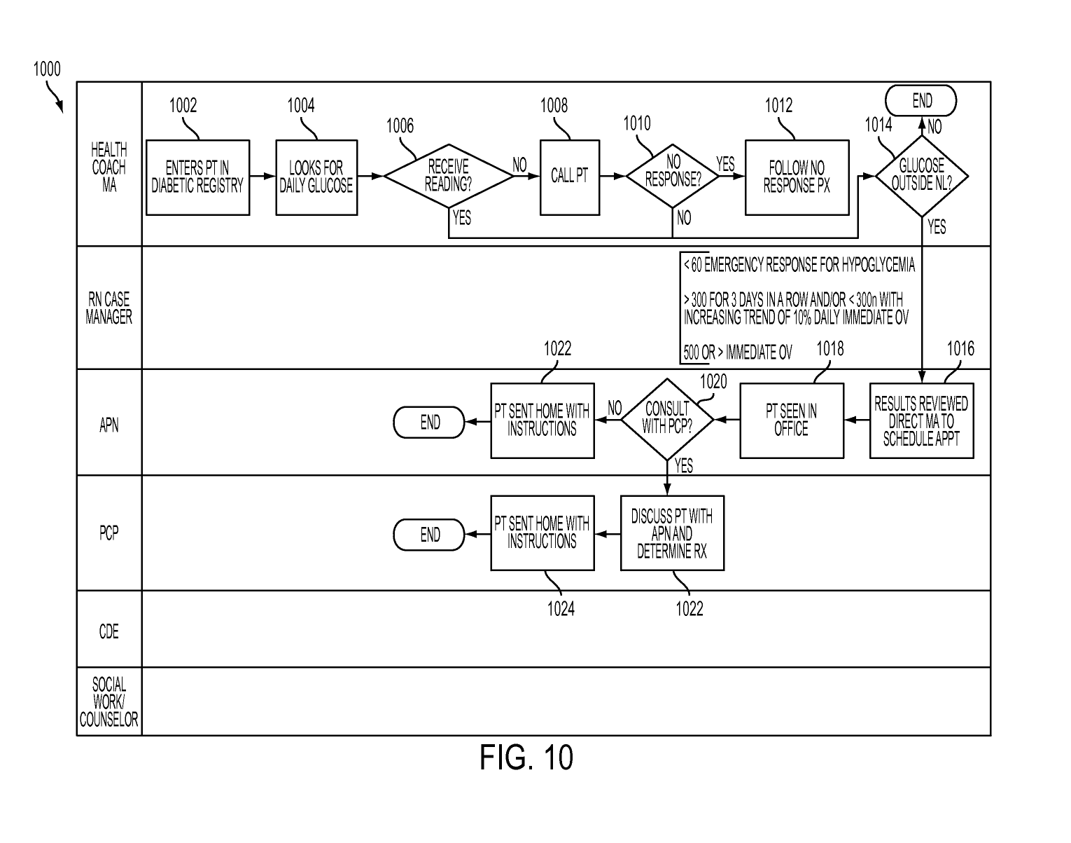

FIG. 10 is a flow chart illustrating an exemplary method for daily care of a diabetes patient in an intensive care program according to one embodiment of the disclosure. A method 1000 begins at block 1002 with a health coach entering the patient in a diabetic registry. The diabetic registry may be stored in the electronic medical record database. At block 1004, the health coach examines the records for daily glucose values. If the glucose reading is available at block 1006 then the method 1000 proceeds to block 1014. If the glucose reading is not available, then the health coach contacts the patient at block 1008. If no response is received at block 1010, then a no response procedure is executed at block 1012. If a response is received then the method 1000 proceeds to block 1014.

At block 1014, the glucose levels are examined. At block 1016, results are reviewed and an advance practice nurse (APN) schedules an appointment for follow-up. At block 1018, the patient is seen in the office by a nurse, who determines at block 1020 whether the patient should consult with a primary care physician. If not, then the patient is sent home with instructions at block 1022. These instructions may be stored in the patient's electronic medical record. If so, then the primary care physician discusses the patient with the nurse and determines whether additional prescriptions or adjustments of prescriptions are necessary. The patient is then sent home with instructions at block 1024.

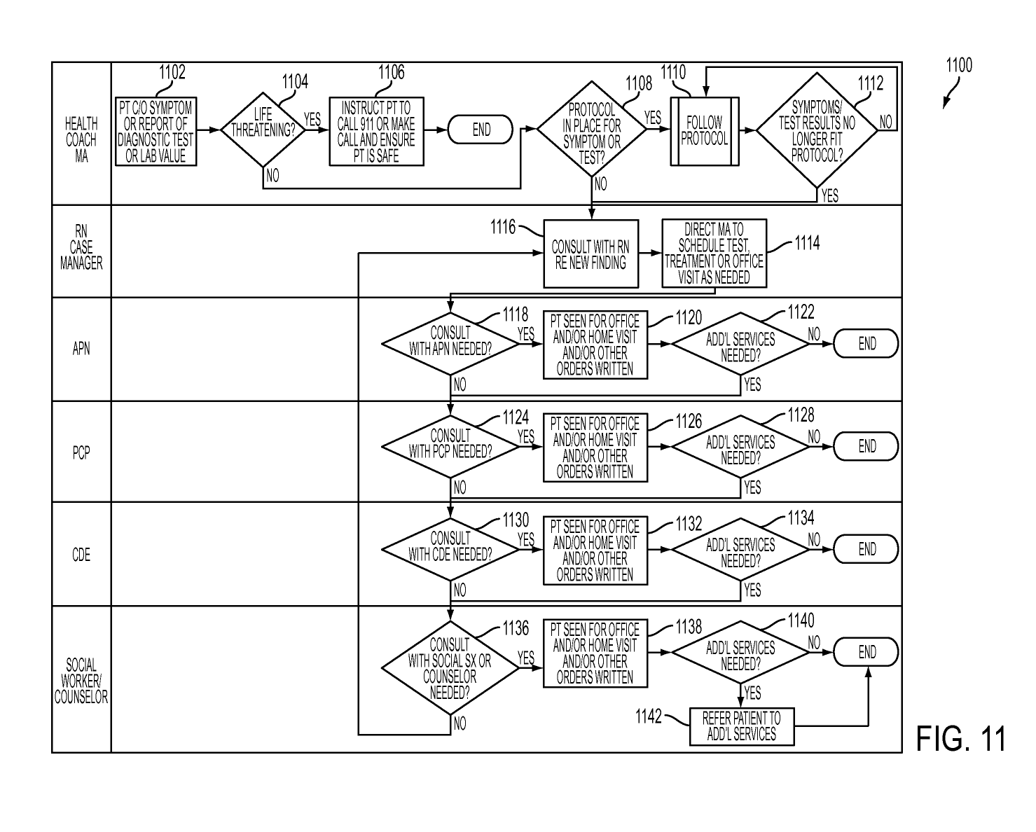

FIG. 11 is a flow chart illustrating an exemplary method for handling urgent issues of a diabetes patient in an intensive care program according to one embodiment of the disclosure. A method 1100 begins at block 1102 with a health coach receiving notification of a new diagnostic test result, lab value, home-monitoring result, or patient-reported symptom. At block 1104, it is determined whether the new information at block 1102 indicates a life threatening situation. If not, then the method 1100 proceeds to block 1108. If yes, at block 1106 the patient is instructed to call 911 or the health coach otherwise ensures the patient's safety. When no life threatening issue was identified, it is determined at block 1108 whether a protocol is in place for the new symptom or test result received at block 1102. If yes, then at block 1110 the protocol is followed until it is determined that the protocol no longer fits the symptom or test results at block 1112. If no protocol is in place, then the method 1100 proceeds to block 1116 to consult with a nurse regarding the new result of block 1102. At block 1114, the nurse directs the health coach to schedule a follow-up test, treatment, or an office visit.

At block 1118, the nurse determines whether the patient should consult with an advanced nurse. If not, then the method 1100 proceeds to block 1124. If yes, then the patient is scheduled for an office or home visit and may be provided with other orders. The orders may be placed in the patient's electronic medical record, where other healthcare professionals may later examine the course of treatment prescribed to the patient during the intensive care program. The orders may include, for example social services or educators. At block 1122, it is determined if additional services are needed. If so, the method 1100 proceeds to block 1124.

At block 1124, it is determined whether the patient should consult with a primary care physician. If not, then the method 1100 proceeds to block 1130. If so, then the patient is scheduled for an office or home visit and may be provided with other orders. At block 1128, it is determined whether additional services are needed. If so, the method 1100 proceeds to block 1130.

At block 1130, it is determined whether the patient should consult with a certified diabetic educator. If not, then the method 1100 proceeds to block 1136. If so, then the patient is scheduled for an office or home visit and may be provided with other orders. At block 1134, it is determined whether additional services are needed. If so, the method 1100 proceeds to block 1136.

At block 1136, it is determined whether the patient should consult with a social worker or a counselor. If not, then the method 1100 proceeds to block 1140. If so, then the patient is scheduled for an office or home visit any may be provided with other orders at block 1138. At block 1140, it is determined whether additional services are needed. If so, the patient may be referred to any number of other additional services as part of the intensive care program at block 1142. For example, the electronic medical record for the patient may indicate the patient has not recently received instruction on food preparation for reducing diabetic issue recurrences.

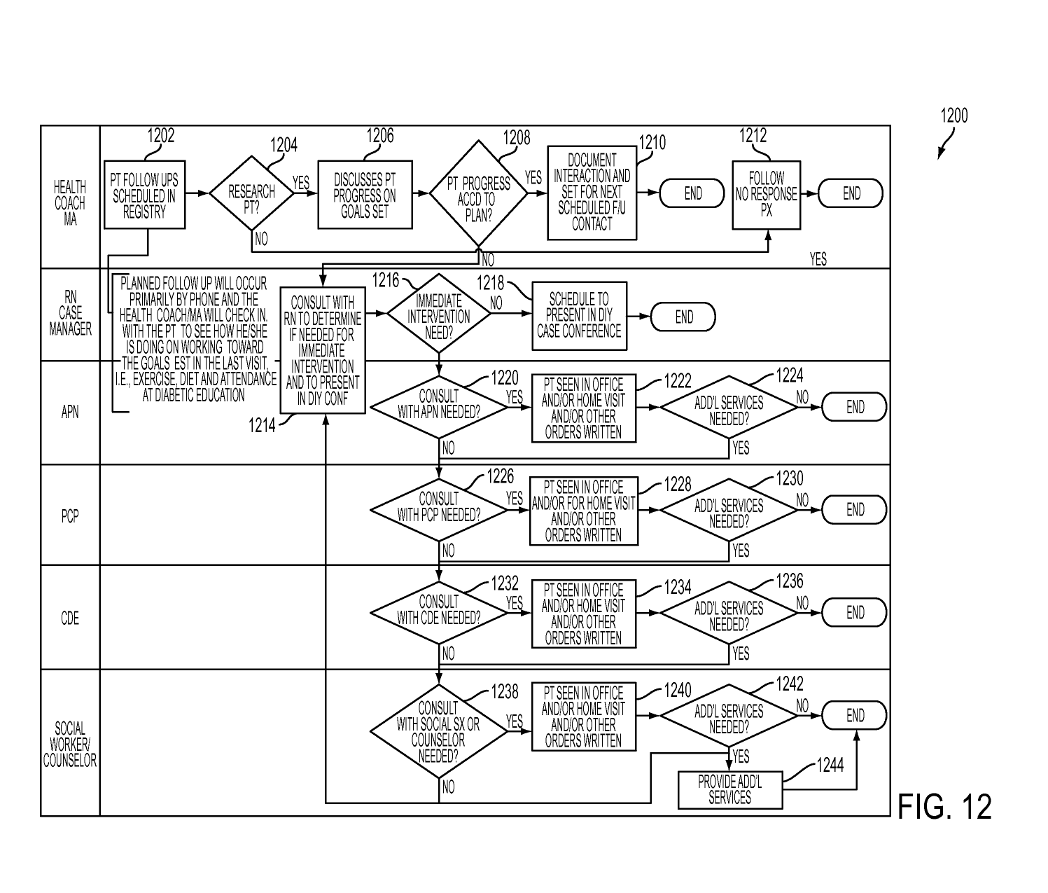

FIG. 12 is a flow chart illustrating an exemplary method for following up with a diabetes patient in an intensive care program according to one embodiment of the disclosure. A method 1200 begins at block 1202 with a health coach following up with the patient. At block 1204, it is determined whether the health coach is able to contact the patient. If not, the method 1200 proceeds to block 1212 to follow a no-response procedure. If contact is made, then the health coach discusses the patient's progress towards reaching goals at block 1206. At block 1208, it is determined whether patient progress is made according to the patient's plan. If yes, then the health coach documents the interaction with the patient in the patient's electronic medical record and schedules another appointment with the patient at block 1210. If progress is not acceptable, then the method 1200 proceeds to block 1214.

At block 1214, a nurse is consulted to determine if immediate intervention is necessary to improve the patient's progress. If immediate intervention is not determined to be necessary at block 1216, then discussion of the patient's plan is scheduled for the next case conference. For example, appropriate notes may be entered in the patient's electronic medical record that are reviewed at the next case conference.

If intervention is necessary, then it is determined whether the patient should consult with an advanced nurse at block 1220. If yes, then the patient is scheduled for an office or home visit with the advanced nurse and patient orders may be provided at block 1222. It may be determined if additional services are necessary at block 1224, and if so then the method 1200 may proceed to block 1226.

At block 1226, it is determined whether the patient should consult with a primary care physician. If not, then the method 1200 proceeds to block 1232. If yes, then the patient may be scheduled for an office or home visit with the primary care physician and patient orders may be provided at block 1228. It may be determined if additional services are necessary at block 1230, and if so then the method 1200 may proceed to block 1232.

At block 1232, it is determined whether the patient should consult with a certified diabetic educator. If not, then the method 1200 proceeds to block 1238. If yes, then the patient may be scheduled for an office or home visit with the certified diabetic educator and patient orders may be provided at block 1234. It may be determined if additional services are necessary at block 1236, and if so then the method 1200 may proceed to block 1238.

At block 1238, it is determined whether the patient should consult with a social worker or counselor. If not, then the method 1200 proceeds to block 1242. If yes, then the patient may be scheduled for an office or home visit with the social worker or counselor and patient orders may be provided at block 1240. It may be determined if additional services are necessary at block 1242. If so, additional services may be scheduled at block 1244 and the method 1200 ends, otherwise the method 1200 ends.

Although a process for identifying high-risk diabetes patients and enrolling high-risk diabetes patients in an intensive care program is described above, an intensive care program may be developed for many other diseases and/or symptoms. The intensive care program may interact with electronic medical records at various stages throughout the intensive care program. For example, as described above patient orders may be entered into electronic medical records, lab test results may entered into electronic medical records, home monitoring data may be entered into electronic medical records, and/or other information may be entered into the patient's electronic medical records. The intensive care program reduces recurrence of symptoms, thus reducing the cost of providing healthcare, by providing the patient with a continuum of services that are coordinated through the patient's electronic medical records.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a plurality of patient health profiles corresponding to a plurality of patients;
identifying a first subset of patients of the plurality of patients at high risk of suffering an episode; and
enrolling a patient from the first subset of patients in an intensive care program designed to reduce the rate of episodes for the patient.

2. The method of claim 1, in which the intensive care program comprises at least one of setting patient goals, setting patient prescription plans, setting patient physical therapy plans, setting patient social services plans, setting patient home assessment plans, setting patient home monitoring plans, setting patient transportation plans, setting patient education plans, and setting patient end-of-life plans.

3. The method of claim 1, further comprising referring the patient to a health coach.

4. The method of claim 3, further comprising receiving, from the health coach, a health care order for the patient, in which the health care order is part of the intensive care program.

5. The method of claim 4, in which receiving the health care order comprises receiving at least one of an order to perform physical exercise, an order to consume medications, and an order to measure blood sugar levels.

6. The method of claim 5, further comprising referring the patient to at least one other medical practitioner located within the same facility as the health coach.

7. The method of claim 1, in which the intensive care program is designed to reduce the rate of episodes related to diabetes for the patient.

8. The method of claim 1, in which the step of identifying the first subset of patients comprises:
receiving results of a telephone survey presented to the plurality of patients;
calculating a first score based on the telephone survey results indicating a risk factor for each patient of the plurality of patients; and
assigning to the first subset of patients each patient of the plurality of patients having the first score above a first predetermined threshold.

9. The method of claim 8, in which the step of identifying the first subset of patients further comprises:
receiving an electronic medical record for each patient of the plurality of patients;
calculating a second score based on the electronic medical record for each patient of the plurality of patients, in which the second score is based on a weighting of factors in the electronic medical record;
calculating a weighted score based on the first score and the second score;
assigning to the first subset of patients each patient of the plurality of patients having the weighted score above a second predetermined threshold.

10. The method of claim 1, further comprising:
monitoring a patient for an indicator of a potential episode; and
referring the patient to a health care coach for follow-up when the indicator is received.

11. A computer program product, comprising:
a non-transitory computer readable medium comprising:
code to receive a plurality of patient health profiles corresponding to a plurality of patients;
code to identify a first subset of patients of the plurality of patients at high risk of suffering an episode; and
code to enroll a patient from the first subset of patients in an intensive care program designed to reduce the rate of episodes for the patient.

12. The computer program product of claim 11, in which the intensive care program comprises at least one of setting patient goals, setting patient prescription plans, setting patient physical therapy plans, setting patient social services plans, setting patient home assessment plans, setting patient home monitoring plans, setting patient transportation plans, setting patient education plans, and setting patient end-of-life plans.

13. The computer program product of claim 11, in which the medium further comprises code to refer the patient to a health coach.

14. The computer program product of claim 13, in which the medium further comprises code to receive, from the health coach, a health care order for the patient, in which the health care order is part of the intensive care program.

15. The computer program product of claim 14, in which the medium further comprises at least one of code to receive at least one of an order to perform physical exercise, code to receive an order to consume medications, and code to receive an order to measure blood sugar levels.

16. The computer program product of claim 15, in which the medium further comprises code to refer the patient to at least one other medical practitioner located within the same facility as the health coach.

17. The computer program product of claim 11, in which the intensive care program is designed to reduce the rate of episodes related to diabetes for the patient.

18. The computer program product of claim 11, in which the medium further comprises:
code to receive results of a telephone survey presented to the plurality of patients;
code to calculate a first score based on the telephone survey results indicating a risk factor for each patient of the plurality of patients; and
code to assign to the first subset of patients each patient of the plurality of patients having the first score above a first predetermined threshold.

19. The computer program product of claim 18, in which the medium further comprises
code to receive an electronic medical record for each patient of the plurality of patients;
code to calculate a second score based on the electronic medical record for each patient of the plurality of patients, in which the second score is based on a weighting of factors in the electronic medical record;
code to calculate a weighted score based on the first score and the second score;
code to assign to the first subset of patients each patient of the plurality of patients having the weighted score above a second predetermined threshold.

20. The computer program product of claim 11, in which the medium further comprises:
code to monitor a patient for an indicator of a potential episode; and
code to refer the patient to a health care coach for follow-up.

21. An apparatus, comprising:
a memory; and
a processor coupled to the memory, in which the processor is configured to:
receive a plurality of patient health profiles corresponding to a plurality of patients;
identify a first subset of patients of the plurality of patients at high risk of suffering an episode; and
enroll a patient from the first subset of patients in an intensive care program designed to reduce the rate of episodes for the patient.

22. The apparatus of claim 21, in which the intensive care program comprises at least one of setting patient goals, setting patient prescription plans, setting patient physical therapy plans, setting patient social services plans, setting patient home assessment plans, setting patient home monitoring plans, setting patient transportation plans, setting patient education plans, and setting patient end-of-life plans.

23. The apparatus of claim 21, in which the processor is further configured to refer the patient to a health coach.

24. The apparatus of claim 23, in which the processor is further configured to receive, from the health coach, a health care order for the patient, in which the health care order is part of the intensive care program.

25. The apparatus of claim 24, in which the processor is further configured to receive at least one of an order to perform physical exercise, receive an order to consume medications, and receive an order to measure blood sugar levels.

26. The apparatus of claim 25, in which the processor is further configured to refer the patient to at least one other medical practitioner located within the same facility as the health coach.

27. The apparatus of claim 21, in which the intensive care program is designed to reduce the rate of episodes related to diabetes for the patient.

28. The apparatus of claim 21, in which the processor is further configured to:
receive results of a telephone survey presented to the plurality of patients;
calculate a first score based on the telephone survey results indicating a risk factor for each patient of the plurality of patients; and
assign to the first subset of patients each patient of the plurality of patients having the first score above a first predetermined threshold.

29. The apparatus of claim 28, in which the processor is further configured to:
receive an electronic medical record for each patient of the plurality of patients;
calculate a second score based on the electronic medical record for each patient of the plurality of patients, in which the second score is based on a weighting of factors in the electronic medical record;
calculate a weighted score based on the first score and the second score;
assign to the first subset of patients each patient of the plurality of patients having the weighted score above a second predetermined threshold.

30. The apparatus of claim 21, in which the processor is further configured to:
monitor a patient for an indicator of a potential episode; and
refer the patient to a health care coach for follow-up.
